(19) United States
(12) Patent Application Publication
(10) Pub. No.: US 2007/0243406 A1
(43) Pub. Date: Oct. 18, 2007

(54) Sliding bearing and method of manufacture

(75) Inventors: Carole L. Trybus, Gregory, MI (US); David M. Saxton, Ann Arbor, MI (US)

Correspondence Address: DICKINSON WRIGHT PLLC, 38525 WOODWARD AVENUE, SUITE 2000, BLOOMFIELD HILLS, MI, 48304-2970, US

(73) Assignee: Federal-Mogul World Wide, Inc.

(21) Appl. No.: 11/405,307

(22) Filed: Apr. 17, 2006

(51) Int. Cl. B32B 15/01

(52) U.S. Cl. 428/648; 384/912

(57) ABSTRACT

A sliding bearing includes a relatively soft first metallic material incorporated into a matrix of a relatively harder second metallic material. The first material is soluble in the second material. Particles of the first material are coated with a protective barrier coating to protect the first material from dissolving in the second material during processing and thereby yielding discrete secondary phases of the first material within the matrix of the second material. The first material may comprise tin or bismuth coated with a barrier coating of nickel within a copper-tin matrix of second material.

### BACKGROUND OF THE INVENTION

1. Technical Field

This invention relates generally to sliding bearings of the type used to journal a rotating shaft.

2. Related Art

Copper is a preferred base material for highly loaded sliding bearings. Tin dissolves in copper under normal processing conditions and strengthens the copper. When there is a need for a secondary soft phase in copper base alloys, manufacturers have historically used lead for its beneficial bearing properties. However, lead is undesirable for environmental and other reasons and thus is less prevalent in modern bearings. Tin has been successfully used as a secondary phase in many aluminum-based bearing alloys. Tin is not soluble in aluminum during processing and thus can be successfully incorporated as a secondary phase and retain its free state during sintering. While aluminum-based alloys make good use of the soft phase properties of tin, they typically do not have sufficient fatigue strength for the most heavily loaded bearing applications that are better suited for copper-based materials. As such, manufacturers of copper-based alloys have had to look for other solutions to achieving good conformability in copper-based sliding bearings.

### SUMMARY OF THE INVENTION

According to the invention, a sliding bearing is provided having a first relatively soft metallic material contained within a matrix of a second relatively harder metallic material, with the first material having the property of being soluble in the second material. At least some of the first material is coated with a protective barrier coating of a third material which forms a protective shell during processing to isolate the first material from the second material and prevent metallurgical interaction in order to provide discrete secondary phases of free first material within the matrix of the secondary material.

The invention can be advantageously utilized to enable secondary free phases of tin to exist in a copper alloy base material of a sliding bearing. Normally, the tin would dissolve into the copper-based matrix during sintering. However, by coating the tin particles prior to processing with the protective barrier coating of nickel, the nickel is able to shield the tin during sintering from metallurgical interaction with the copper-based particles of the matrix in order to yield the secondary phases of free tin within the copper-based matrix following sintering. It will be appreciated by those skilled in the art that the same technique can be employed to enable a bearing manufacturer to incorporate whatever soft phase is desired into the harder matrix material by coating particles of the softer material with a protective barrier coating. Other examples include, but are not limited to, the inclusion of secondary phases of bismuth within a copper-based matrix.

The invention has the advantage of providing a means of incorporating a soft bearing material such as tin into a matrix of a harder parent material such as copper-based alloys in a way that shields the softer material from dissolving into the matrix during processing in order to develop secondary phases of the free first material in the final product. One preferred means of achieving this objective is through powder metallurgy, in which particles of the first material are coated with the protective barrier coating and then combined and sintered with particles of the second matrix material according to usual processing techniques for sintered bearings, but with the characterizing feature being that the barrier coating shields the metallurgical interaction of the first material with the second matrix material and prevents is from dissolving during sintering to form the secondary phases of the free first material in the final product.

A bearing having such secondary phases of the softer material has the advantage of providing free soft phases which enhance the conformability of the bearing. When tin is selected as the soft phase material and coated with nickel for use in copper-based bearings, other secondary phases which may form as a result of sintering include tin-nickel and/or tin-nickel-copper intermetallics which may result from interaction of the tin with the nickel coating or from a breakdown in the coating of some particles where the copper is allowed to interact with the tin and nickel to form such intermetallics in addition to the discrete free tin phases. The intermetallic phases provide relatively hard regions in the matrix which enhance the wear and seizure resistance characteristics of the bearing material.

### BRIEF DESCRIPTION OF THE DRAWINGS

These and other features and advantages of the present invention will become more readily appreciated when considered in connection with the following detailed description and appended drawings, wherein:

FIG. 1 is a schematic fragmentary sectional view of an illustrative bearing; and

FIG. 2 is a schematic enlarged view of the encircled region of FIG. 1.

### DETAILED DESCRIPTION OF THE PREFERRED EMBODIMENT

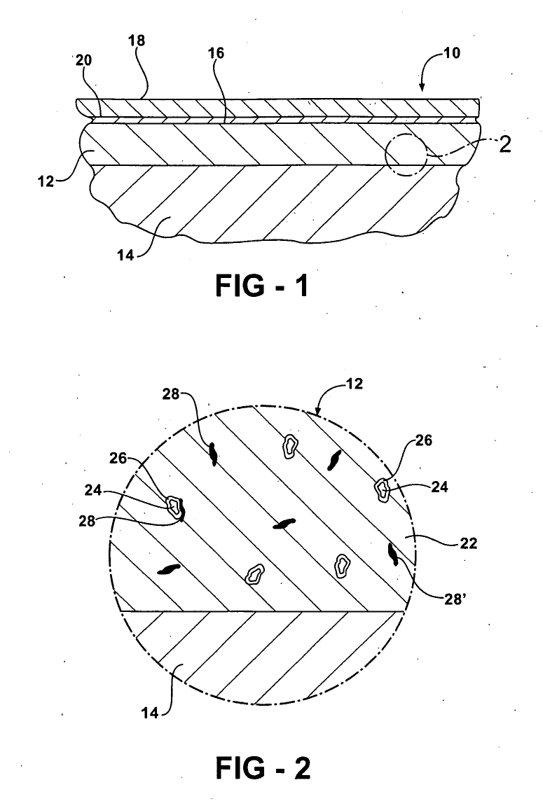

A sliding bearing constructed according to an exemplary embodiment of the invention is shown generally at 10 in FIG. 1 and includes a bearing layer 12 applied to a substrate 14. A running surface 16 of the bearing layer 12 may be exposed or covered with one or more overlays 18 and, if necessary, an intervening barrier layer 20 to prevent metallurgical interaction between the overlay 18 and bearing layer 12. The bearing layer 12 may be a copper-based alloy, such as copper-tin, while the overlay 18 may be a layer of pure tin, and the barrier layer 20 may be of nickel. The substrate 14 represents a selected base material on which the bearing layer 20 is applied. For example, the substrate 14 may comprise a steel backing of a half-shell type bearing, the base metal of a connecting rod or engine block or other such substrate.

Details of the bearing layer 12 are further schematically illustrated in FIG. 2. The layer 12 includes a matrix 22 of a second material in which discrete secondary phases of a first material 24 are present and are coated with a protective barrier layer 26 of a third material. The first material 24 is a relatively soft metallic material that has the property of being soluble in the second matrix material 22, which is a relatively harder metallic material. The third material 26 represents a protective coating which shields and protects at least some of the softer phase material during formation of the bearing layer 12 from dissolving in the matrix 22. In a preferred embodiment, the matrix material 22 represents the copper-based material, such as copper-tin, the soft phase 24 is preferably tin or bismuth, and the protective layer 26 is preferably nickel. Of course, other materials which behave in the same or similar manner to achieve the same or similar result in the same or similar way are contemplated within the scope of the invention as obvious equivalents.

In a preferred process, particles of tin 24 are coated with the protective nickel barrier 26. These particles are blended with particles of the matrix material 22 and are sintered and formed to the desired shape. For example, the materials may be sintered and then roll bonded to a metal strip (substrate 14) to yield one type of a sliding bearing or bushing. It is to be understood that the term sliding bearing is meant to incorporate full or half shell bearings, bushings, and bearing materials applied directly to any desired substrate to yield a bearing surface for supporting sliding movement of another object, such as a rotating shaft.

During sintering, the materials are heated and preferably above the melting temperature of the first material, but below that of the third material. But for the presence of the protective coating 26, the first material 24 would interact directly with the material of the matrix 22 under the sintering conditions and would dissolve partially or completely into the matrix material. The barrier layer 26 prevents this from happening by introducing a physical barrier between the first material particles 24 and the matrix material 22 during sintering. Consequently, at least some of the first material particles 24 survive the sintering process and are present in the final bearing material 12 as discrete secondary phases of the first material 24. Using the preferred materials as an example, the resultant copper-tin matrix material 22 would have secondary phases of free tin 24 contained within the matrix covered with a protective coating of nickel 26.

It is contemplated that at least some of the coated tin particles may have an imperfect barrier coating or one which gets disturbed during processing such that some metallurgical interaction may take place with the matrix material 22 and some of the coated particles 24. This may yield intermetallic regions 28 of tin-nickel-copper and/or tin-nickel in the matrix 22. These intermetallics would be considerably harder than the matrix material 22 and enhances the wear and seizure resistance of the bearing material 12, wherein the presence of the secondary soft phases 24 enhances conformability on the material 22.

As illustrated in FIG. 1, the subject bearing material 12 can be used alone or in connection with a multi-layer bearing system in which, for example, an overlay of pure tin 18 is applied to the bearing layer 22 with use of an intervening nickel layer 20 to prevent the tin from migrating into the copper-based matrix 22.

Obviously, many modifications and variations of the present invention are possible in light of the above teachings. It is, therefore, to be understood that within the scope of the appended claims, the invention may be practiced otherwise than as specifically described.

What is claimed is:

1. A sliding bearing, comprising:
a relatively soft first material contained in a matrix of a relatively harder second material, with said first material being at least partially soluble within said second material, and
wherein at least some of said first material is covered by a protective barrier coating of a third material to define discrete undissolved phases of the first material within said matrix of said second material.

2. The sliding bearing of claim 1, wherein said second matrix material comprises a copper-based alloy.

3. The sliding bearing of claim 2 wherein said first material comprises tin.

4. The sliding bearing of claim 2 wherein said first material comprises bismuth.

5. The sliding bearing of claim 3 wherein said third material comprises nickel.

6. The sliding bearing of claim 4 wherein said third material comprises nickel.

7. The sliding bearing of claim 5 including at least one intermetallic phase contained in said matrix.

8. The sliding bearing of claim 7 wherein the intermetallic phase comprises copper-nickel-tin.

9. The sliding bearing of claim 7 wherein the intermetallic phase comprises tin-nickel.

10. The sliding bearing of claim 7 wherein the intermetallic phase comprises copper-nickel-tin and tin-nickel.

11. The sliding bearing of claim 1 wherein said sliding bearing is essentially lead-free.

12. A method of making a sliding bearing, comprising:
preparing a second metallic material;
preparing particles of a first metallic material that is at least partially soluble in the second metallic material;
coating at least some of the particles of the first material with a barrier coating of a third material; and
incorporating the coated particles of the first material into a matrix of the second material to provide isolated phases of the first material in the second matrix material surrounded by the coating of the third material.

13. The method of claim 12 wherein the coated particles of the first material are incorporated by blending and sintering the coated first particles with the second material.

14. The method of claim 13 wherein the second material is selected as a copper-based alloy.

15. The method of claim 14 wherein the first material is selected as tin.

16. The method of claim 15 wherein the first material is selected as bismuth.

17. The method of claim 15 wherein intermetallics of tin-nickel are formed in the matrix.

18. The method of claim 15 wherein intermetallics of copper-nickel-tin are formed in the matrix.
